(19) United States
(12) Patent Application Publication
(10) Pub. No.: US 2005/0220956 A1
(43) Pub. Date: Oct. 6, 2005

(54) Method and device for shaping foodstuffs and the like, and shaped product

(76) Inventor: Noriyuki Hiragaki, Shizuoka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/508,155

(22) PCT Filed: Mar. 24, 2003
(86) PCT No.: PCT/JP03/03545

§ 371 Date: Sep. 17, 2004

(30) Foreign Application Priority Data
Mar. 22, 2002 (JP) 2002-82166

(51) Int. Cl. A01J 1/00

(52) U.S. Cl. 426/512

(57) ABSTRACT

A method for shaping foodstuffs and the like, which improves operating efficiency and economic efficiency when a foodstuff, such as taro or aroid, is to be shaped to be spherical; and a device therefor. A shaping procedure using cutter blades (15) applied to process subject articles (A) to shape the surface of each of the process subject articles (A), wherein the process subject articles (A) and the cutter blades (15) are relatively moved and the process subject articles (A) can be held in a floating state when they are subjected to the cutter blades (15). Since the process subject articles (A) are maintained in a floating state, as soon as the process subject articles (A) come into contact with the cutter blades (15) to have their surfaces cut, the floating state or rotative state is imparted to the process subject articles (A) to some extent by the cutter blades (15), and such states are continued, whereby the surfaces are thoroughly cut to be spherical or the like.

### TECHNICAL FIELD

The present invention relates to a method for shaping foodstuffs, etc., a device therefor, and shaped products produced thereby, preferably used for foodstuff such as aroid or taro, to be shaped to be spherical, so that the demand of consumers may be satisfied.

### BACKGROUND ART

Taro or aroid is one of popular foodstuffs, and according to the preference of consumers, it is shaped, as an intermediate process, to be substantially in a size of golf ball, together with the peeling thereof. Thereafter, the shaped aroids are packed by the predetermined numbers, and during distribution, they are supplied in the frozen state when necessary.

During this intermediate process, because the subject of process is aroid, i.e. natural product, each shape is of course not regular, and therefore, it is very difficult to shape them by using any mechanical device. Thus, although the efficiency and cost may not be ideal, the intermediate process should be done by manual working. Hence, for those who relates to the food production industry, the intermediate process should naturally be done in low-cost region or country in order to reduce the production cost. However, when the added value, and the distribution and selling cost are totally taken into account, further reduction of cost should be accomplished. Therefore, it is the demand of this kind of industry, to provide a device for the intermediate process, which may become in place of conventional, cost-overrun manual working.

When the demand of such machine processing should be met, the utilization of conventional process method such as “turning” or “gouging” may be considered first, as a technically possible method, wherein aroids in various shapes may be held and rotated, and a cutter blade may be applied thereto (for example, see claims and FIG. 5 of the Official Gazette of Japanese unexamined patent publication No. Sho 62-175159). However, this method would require the preparation that an aroid, as a process subject article, is caught by chuck and rotated. Such a preparation would cause any undesirable situation, and may not be practical. Since aroids will be ordinarily cooked by maintaining the peeled shape, if the marking by chuck during the intermediate process remains on the surface of the process subject article, the product value will be deteriorated. Further, when there is a considerable process friction between the cutter blade and the process subject article, the shape of the process subject article will be destroyed. On the other hand, if the chucking is done carefully by considering the above problem, the preparation itself would require a considerable long time, which will not accomplish the object of invention, i.e. improvement of working efficiency and lower cost. Thus, when the automated shaping process of aroids by mechanical device is accomplished, the fundamental change in thinking, apart from conventional working or process method for industrial products and industrial parts, should be required.

Further, as illustrated on the first page and in FIG. 1 of the Official Gazette of Japanese Examined Patent Publication No. Sho 60-17503, there is also a peeling device, comprising a cylindrical case having a horizontal rotative cutter blade at the bottom thereof, so that the peeling is done when the process subject article is put into the case. However, when too many subject articles are put into the case, each subject article would collide with each other, thus the excellent finish cannot be expected. On the other hand, when the subject articles are put little by little, the putting in and taking out of the subject articles would be laborious, and although such working will be done easily for the household purpose, if there are many subject articles for peeling, the total working time would become longer. Further, there is another problem that the process time should be adjusted according to the quantity of put subject articles. In any case, according to the peeling device as disclosed in the Patent Document 2, having the cutter blade at the bottom of the case, the problems remain in regard to the peeling speed and the unified finish.

### DISCLOSURE OF INVENTION

According to claim 1 of the present invention, there is provided a method for shaping foodstuffs and the like, by applying cutter blades to process subject articles in order to shape a surface of each of the process subject articles, characterized in that: the process subject articles and the cutter blades are relatively moved, and the process subject articles can be held in a floating state when the cutter blades are applied to the process subject articles.

Therefore, when the process subject article is faced to the cutter blades, as the floating state is maintained, the process subject article becomes in contact with the cutter blades and the surface is cut, and at the same time, the cutter blades somewhat give the floating state or rotative state continuously, whereby the surface is cut uniformly and for example to be a desired spherical shape.

According to claim 2 of the present invention, there is provided the method for shaping foodstuffs and the like, which is characterized, in addition to the features as claimed in claim 1, that the cutter blades have a rotative tracking.

Therefore, it is possible to provide a reasonable layout of the relative process area between the cutter blades and the process subject articles.

According to claim 3 of the present invention, there is provided the method for shaping foodstuffs and the like, which is characterized, in addition to the features as claimed in claim 1 or 2, that the cutter blades have a combined effective blade shape of a letter U.

Therefore, even if the initial shape of the process subject articles is not spherical, it is possible to finish them in the spherical shape.

According to claim 4 of the present invention, there is provided the method for shaping foodstuffs and the like, which is characterized, in addition to the features as claimed in claim 1, 2 or 3, that the relative movement is done by rotating a rotative drum provided with the cutter blades, and through natural drop of the process subject articles in a process room.

Therefore, the shaping can be done without requiring any special measure for facilitating the movement of the process subject articles.

According to claim 5 of the present invention, there is provided the method for shaping foodstuffs and the like, which is characterized, in addition to the features as claimed in claim 4, that the rotative drum rotates substantially in the perpendicular direction, having the cutter blades on its outer periphery, and the outer periphery of the rotative drum is covered by a feeding guide unit, in order to form the process room having a passage space which allows passing of one process subject article; and the cutter blades rotate in the direction opposite to the dropping direction of the process subject articles.

Therefore, since the shaping can be done, by using natural drop of the process subject article, continuously without requiring any special intermediate stop of the device, the workability is excellent. Further, as the process room has the passage space which substantially allows the passing of one process subject article, there is no possibility that several process subject articles might become obstacles to the shaping process of the other process subject articles with each other. Thus, it is possible to obtain the process subject articles, each of which finish is almost desired uniformed shaping.

According to claim 6 of the present invention, there is provided the method for shaping foodstuffs and the like, which is characterized, in addition to the features as claimed in claim 1, 2, 3, 4 or 5, that a mechanism for discharging cut skins is provided near the cutter blades.

Therefore, it is possible to discharge the cut skins, etc., smoothly, whereby the stable continuous operation can be done.

According to claim 7 of the present invention, there is provided a device for shaping foodstuffs and the like, by applying cutter blades to process subject articles in order to shape a surface of each of the process subject articles, characterized in that: the process subject articles and the cutter blades are relatively moved, and the process subject articles can be held in a floating state when the cutter blades are applied to the process subject articles.

With this structure, when the process subject article is faced to the cutter blades, as the floating state is maintained, the process subject article becomes in contact with the cutter blades and the surface is cut, and at the same time, the cutter blades somewhat give the floating state or rotative state continuously, whereby the surface is cut uniformly and for example to be a desired spherical shape.

According to claim 8 of the present invention, there is provided the device for shaping foodstuffs and the like, which is characterized, in addition to the structure as claimed in claim 7, that the cutter blades have a rotative tracking.

With this structure, it is possible to provide a reasonable layout of the relative process area between the cutter blades and the process subject articles.

According to claim 9 of the present invention, there is provided the device for shaping foodstuffs and the like, which is characterized, in addition to the structure as claimed in claim 7 or 8, that the cutter blades have a combined effective blade shape of a letter U.

With this structure, even if the initial shape of the process subject articles is not spherical, it is possible to finish them in the spherical shape.

According to claim 10 of the present invention, there is provided the device for shaping foodstuffs and the like, which is characterized, in addition to the structure as claimed in claim 7, 8 or 9, that the relative movement is done by rotating a rotative drum provided with the cutter blades, and through natural drop of the process subject articles in a process room.

With this structure, the shaping can be done without requiring any special measure for facilitating the movement of the process subject articles.

According to claim 11 of the present invention, there is provided the device for shaping foodstuffs and the like, which is characterized, in addition to the structure as claimed in claim 10, that the rotative drum rotates substantially in the perpendicular direction, having the cutter blades on its outer periphery, and the outer periphery of the rotative drum is covered by a feeding guide unit, in order to form the process room having a passage space which allows passing of one process subject article; and the cutter blades rotate in the direction opposite to the dropping direction of the process subject articles.

With this structure, since the shaping can be done, by using natural drop of the process subject article, continuously without requiring any special intermediate stop of the device, the workability is excellent. Further, as the process room has the passage space which substantially allows the passing of one process subject article, there is no possibility that several process subject articles might become obstacles to the shaping process of the other process subject articles with each other. Thus, it is possible to obtain the process subject articles, each of which finish is almost desired uniformed shaping.

According to claim 12 of the present invention, there is provided the device for shaping foodstuffs and the like, which is characterized, in addition to the structure as claimed in claim 7, 8, 9, 10 or 11, that a mechanism for discharging cut skins is provided near the cutter blades.

With this structure, it is possible to discharge the cut skins, etc., smoothly, whereby the stable continuous operation can be done.

According to claim 13 of the present invention, there is provided the device for shaping foodstuffs and the like, which is characterized, in addition to the structure as claimed in claim 7, 8, 9, 10, 11 or 12, that the device for shaping foodstuffs and the like further comprises: a shaping device body, in which the process subject articles and the cutter blades are relatively moved, and the process subject articles can be held in a floating state when the cutter blades are applied to the process subject articles; and a preparation device, which cuts the process subject articles in advance to be in a predetermined shape so that a shaping process by the shaping device body can be done easily; the preparation device comprising: a receive cylinder, continuously connected to a feeding mouth of the shaping device body, and supporting one process subject article at a process start end; a feeding cutter blade, capable of being inserted in the receive cylinder and having substantially the same inner shape as that of the receive cylinder; and a mounting device which places the process subject articles on the receive cylinder at predetermined intervals.

With this structure, since the process subject articles are fed to the shaping device body at predetermined intervals, there is almost no possibility of the process subject articles being blocked during shaping process in the shaping device body. Further, it is not necessary to provide a cutting device (crude processing device) other than the device for shaping foodstuffs and the like, and it is also not necessary to provide a conveyor connecting between a cutting device and the shaping device. Because the overall structure of the device is not a production-line type, the overall size of the device may become smaller, thus the device may be placed almost anywhere, even in a narrow space.

According to claim 14 of the present invention, there is provided the device for shaping foodstuffs and the like, which is characterized, in addition to the structure as claimed in claim 13, that the feeding cutter blade is provided, at the center thereof, with a pushing rod movable in the forward and rearward directions toward the receive cylinder, and with a force applying member, which applies force to the pushing rod toward the inside of the receive cylinder.

With this structure, after the cutting of the process subject article by the feeding cutter blade, the process subject article is pushed by the pushing rod, and dropped into the receive cylinder smoothly.

According to claim 15 of the present invention, there is provided the device for shaping foodstuffs and the like, which is characterized, in addition to the structure as claimed in claim 13 or 14, that the receive cylinder is provided substantially in a vertical state, in which a V-shape groove is formed in the top of the process start end.

With this structure, because the receive cylinder is provided substantially in vertical state, the process subject article after preparation is dropped smoothly, by natural drop, into the feeding mouth of the shaping device body. Further, because the V-shape groove is formed in the process start end at the top, the placing stability of the process subject article when being placed thereon is good, and there is no risk that the process subject article might fall down from the process start end of the receive cylinder, and there is also very little risk of wrong mounting by the mounting device.

According to claim 16 of the present invention, there is provided the device for shaping foodstuffs and the like, which is characterized, in addition to the structure as claimed in claim 13, 14 or 15, that the mounting device is provided with support rods for supporting process subject articles on a feeding surface of a slat conveyor; and slits are formed in the vertical direction in the receive cylinder in order to avoid collision of the cylinder with the support rods.

With this structure, the mounting device may have a simple structure, and the production cost thereof may be reduced. Further, because of the structure by the support rods and the slits, the process subject articles may be placed on the process start end of the receive cylinder without any giving any impact, whereby the wrong mounting can be avoided remarkably. As the slat conveyor has the good rigidity, the support rods surely support the process subject articles even at the feeding end.

According to claim 17 of the present invention, there is provided a shaped product, of which a surface is shaped by applying cutter blades to a process subject article, characterized in that: the process subject article and the cutter blades are relatively moved, and the process subject article can be held in a floating state when the cutter blades are applied to the process subject article; and surface of the process subject article is shaped by any method as claimed in claim 1, 2, 3, 4, 5 or 6 or by any device as claimed in claim 7, 8, 9, 10, 11, 12, 13, 14, 15 or 16.

Therefore, it is possible to provide products to market, which have been shaped to be in a desired shape.

According to claim 18 of the present invention, there is provided the shaped product, which is characterized, in addition to the structure as claimed in claim 17, that the process subject article is aroid, and is shaped to be spherical.

Therefore, although the process subject articles may be aroids, which have been considered as difficult materials for shaping, it is possible to obtain these products in a desired shape, by reasonable, efficient and cost-reducing shaping.

### BRIEF DESCRIPTION OF DRAWINGS

FIG. 1 is a side view showing a using state of a device for shaping foodstuffs and the like;

FIG. 2 is a plan view thereof;

FIG. 3 is an expanded side view of a preparation device;

FIG. 4 is an exploded perspective view of a process head of a shaping device body;

FIG. 5 is a side view thereof;

FIG. 6 is an explanatory view showing each working stage of the preparation device;

FIG. 7 is an explanatory view showing a working state of the cutter blade of the shaping device body;

FIG. 8 is a schematic side view showing another embodiment of a mounting device having a different structure;

FIG. 9 is an explanatory view showing a working state of another embodiment of a mounting device which can move a receive cylinder in upward and downward directions;

FIG. 10 is an explanatory view showing an embodiment (a) in which a receive cylinder is placed in an inclined state, and an embodiment (b) in which the receive cylinder is placed in a horizontal state;

FIG. 11 is a perspective view showing another embodiment of a preparation device having two feeding cutter blades adjacent to each other;

FIG. 12 is a perspective view of an independent type of preparation device having two feeding cutter blades adjacent to each other;

FIG. 13 is a perspective view showing another embodiment of a device for shaping foodstuffs and the like, provided with a hopper instead of a preparation device;

FIG. 14 is a side view showing three other types of cutter blades;

FIG. 15 is a side view, showing another embodiment of a shaping device body provided with cutter blades on a belt base member, and showing another embodiment in which process subject articles are moved by bringing them in contact with fluid;

FIG. 16 is a side view showing two other embodiments having different process heads;

FIG. 17 is an explanatory view showing another embodiment provided with two-stage process heads; and

FIG. 18 is a perspective view showing an embodiment together with auxiliary devices.

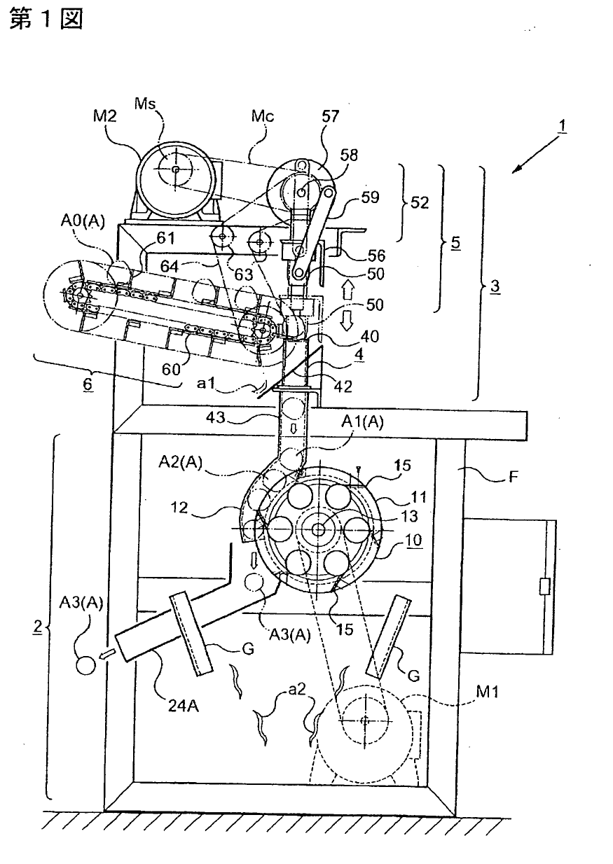

### BEST MODE FOR CARRYING OUT THE INVENTION

The present invention will be explained with reference to embodiments as illustrated in attached drawings. For the purpose of this explanation, a basic embodiment of a device for shaping foodstuffs and the like will be discussed first, and thereafter, practical shaping methods and shaped products will be discussed with reference to the working states of the device. Further, other embodiments will be discussed.

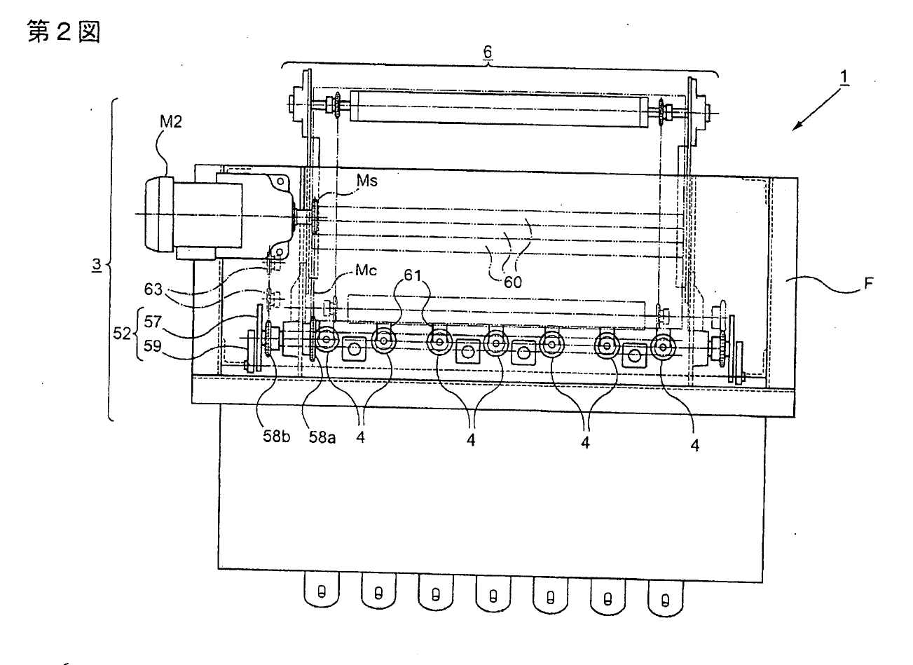

There is a foodstuff shaping device 1 according to the present invention, which applies cutter blades 15 to process subject articles A, whereby the surface of the process subject article A is shaped. The process subject articles A and the cutter blades 15 are moved relatively. There is a shaping device body 2, in which, the process subject articles A can be held in a floating state, when the cutter blades 15 are applied to the process subject articles A. There is also a preparation device 3, which cuts each of the process subject articles A to be in a predetermined shape suitable for shaping. The preparation device 3 is continuously connected to the shaping device body 2, by a feeding mouth 22. The feeding mouth 22 is continuously connected to a process room 21, in which the shaping is done. As illustrated in FIG. 2, according to the present embodiment, although there are seven devices provided in parallel, having the same structure, respectively comprising the shaping device body 2 and the preparation device 3, it is also possible to provide two or three devices, or even one device.

The shaping device body 2 will be explained. The shaping device body 2 comprises a process head 10 incorporated in a frame F, serving as one of chief elements. The process head 10 comprises, as chief elements, a blade unit 11, and a feeding guide unit 12 placed along the blade unit 11. For the purpose of the explanation hereinafter, aroids will be used as an example of the process subject article A. The process subject article before shaping process is shown by reference sign A0, and that during the shaping process by the shaping device body 2 is shown by reference sign A1, and that after the shaping process is shown by reference sign A3, and they are collectively shown by reference sign A. There are parts removed by the preparation device 3, which are called as cut chips a1. Further, there are parts to be removed by the shaping device body 2 from the process subject articles A, which are called as skins a, and these parts, after removal, are called as cut skins a2.

The frame F comprises structural members having a suitable strength, and shell members serving as outer panels. The process head 10 is incorporated in the frame F, and the blade unit 11 of the process head 10 is driven by a driving motor M1. There is a drive shaft 13, provided directly or via an appropriate speed reduction or control mechanism, to which a rotative drum 14 of the blade unit 11 is connected. The rotative drum 14 has a plurality of cutter blades 15, for example six cutter blades 15 at respective six positions. The outer peripheral surfaces of the cutter blades 15 and the rotative drum 14 are both recessed inwardly, for example in the shape of pulley. There is a position at which this recessed part, i.e. an outer periphery recessed part 14A is combined with the feeding guide unit 12, and this position serves as a space for shaping the process subject article A. The side surface of the rotative drum 14 has been somewhat carved, in order to reduce the weight, and serves as a thin part 14B. The outer periphery of the thin part 14B is inclined to be in a taper shape, forming a discharge guide surface 14C for the cut skins a2, which will de discussed afterwards.

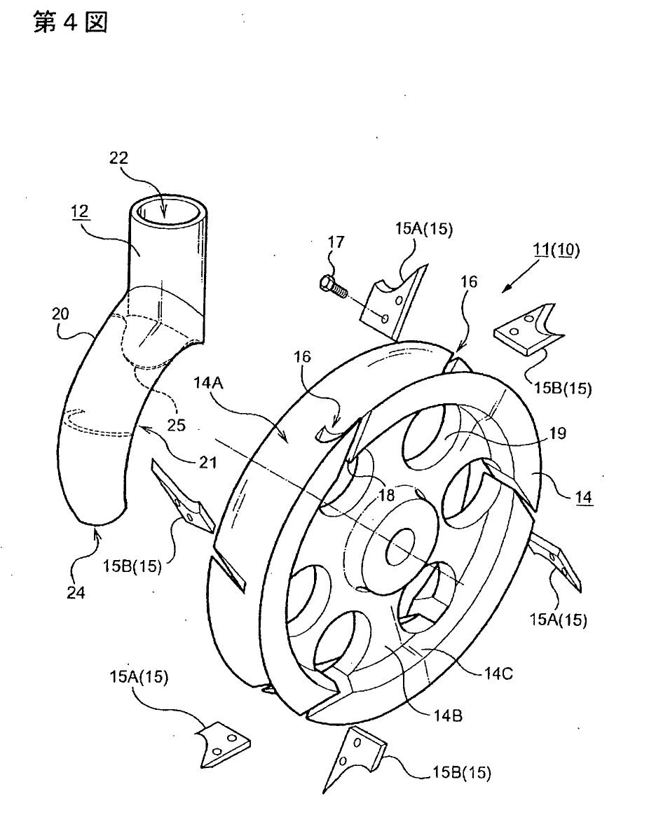

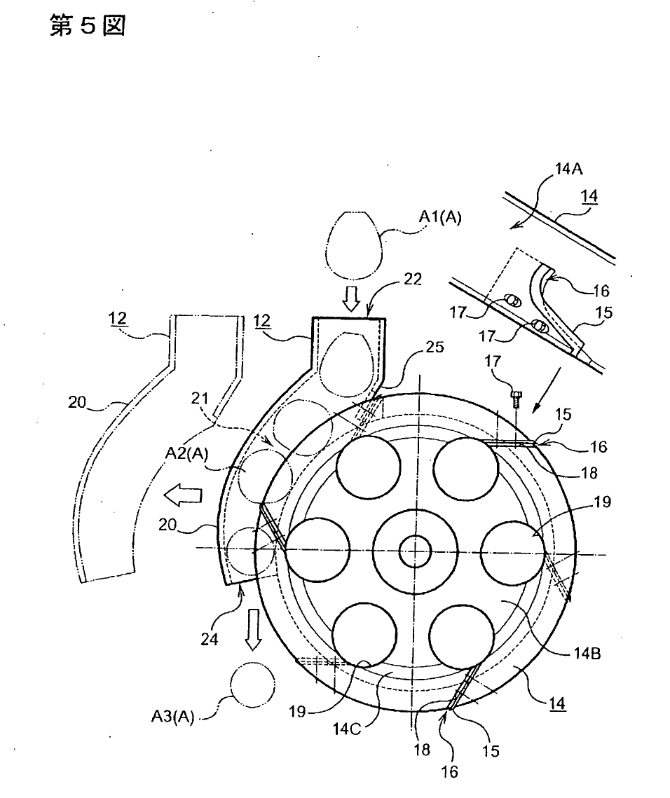

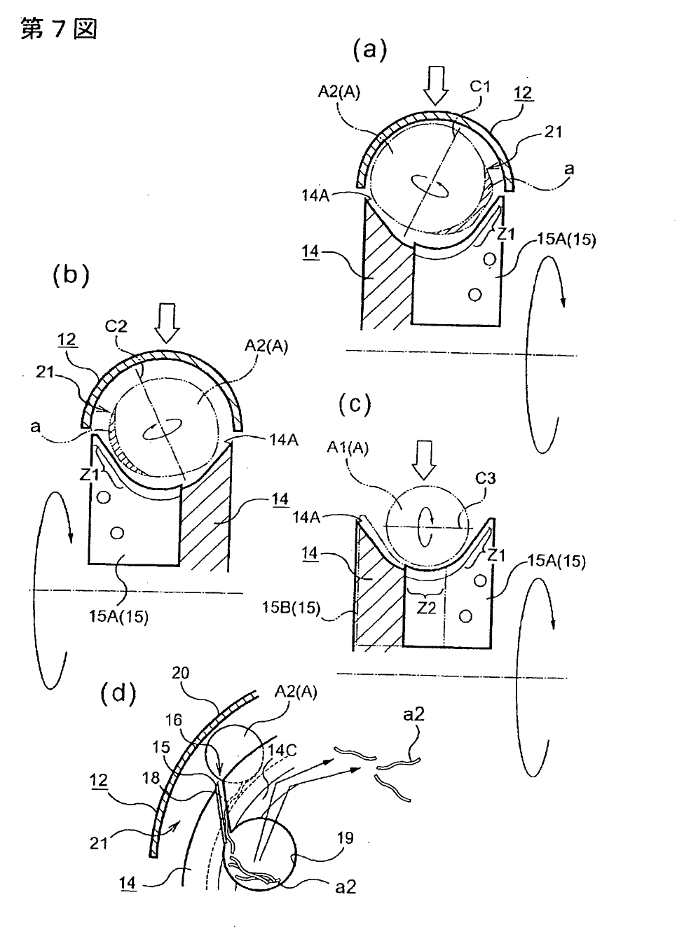

As an example, the cutter blades 15 comprise cutter blade chips 15A, 15B, respectively serving as the right-side and left-side cutters, provided one after the other (see FIGS. 4 and 5). When the tips of the cutter blade chips 15A, 15B are projected together, the effective blade would form a U-letter shape as a whole (see FIG. 7(c)). For example, when aroids, etc. are used as the process subject articles A, if they should be formed to be spherical, the projected shapes of the cutter blade chips 15A, 15B may preferably be overlapped. The inclined parts substantially from the side edges to the centers are referred to as side effective portions Z1, and the overlapping portions at the center of the lower parts are referred to as bottom effective portions Z2. The bottom effective portions Z2 are overlapped (see FIG. 7).

With reference to the assemble structure of the cutter blades 15 and the rotative drum 14, there are cutter blade receiving parts 16, respectively in the shape of slit, inclined substantially in a swirling direction as a whole, from the peripheral surface of the rotative drum 14 to the center thereof, at which each of the cutter blades 15 is fixed by a fixing means 17, such as a bolt. The gap size of each slit of the cutter blade receiving part 16 is sufficiently larger than the thickness of the cutter blade 15, so that the remaining space formed at that part may serve as an escape space 18 for the cut skins a2. The bottom ends of these escape spaces 18 for the cut skins a2 (i.e. the parts close to the center of the rotative drum 14) have been formed as predetermined circular spaces, serving as remaining chips discharge pockets. The width of the cutter blade receiving parts 16 in the direction of thickness (the axis direction) of the rotative drum 14 is somewhat larger than the width of the cutter blade 15. It is of course possible to form the cutter blade receiving parts 16, by wholly cutting the rotative drum 14 in the direction of thickness.

The feeding guide unit 12 is provided, in a shape that the blade unit 11 in the above structure is accepted from the upper part to the lower part in the rotative direction, covering the surface thereof from the top to the side part. The feeding guide unit 12 comprises a guide trough 20 as a chief part. The guide trough 20 is in the shape of, for example, a cross-sectional half circle, of which side surface substantially goes along the peripheral curvature of the rotative drum 14. The guide trough 20 and the outer periphery recessed part 14A of the rotative drum 14 substantially form the space serving as the process room 21. The process room 21 is substantially in the shape of cross-sectional circle as a whole, of which diameter just allows the passing of one process subject article A1 as shown in FIG. 7, having a larger upper part and a smaller lower part. The feeding guide unit 12 is provided with the feeding mouth 22 at the top of the guide trough 20, and a receive cylinder 4 of the preparation device 3 is connected to the feeding mouth 22 via a connecting chute 43.

The bottom of the guide trough 20 is cut-off, at which an outlet 24 is substantially formed, serving as the discharge end of the process room 21. Further, a blocker plate 25 is provided, at the position below the feeding mouth 22 and facing to the outer periphery recessed part 14A of the rotative drum 14 of the blade unit 11, in the shape of blocking that space, inclined toward the connecting part, which substantially serves, when the process subject articles A are fed from the feeding mouth 22, to guide the process subject articles A to the process room 21 smoothly. It is preferable that, when any trouble occurs in the process room 21, as illustrated by imaginary lines in FIG. 5, one guide trough may be removed easily, so that the inspection such as the removal of the process subject articles A may be done. The frame F is provided with an ejector chute 24A connected to the outlet 24. Further, as it is not desirable to leave the scattered cut skins a2, a guide plates G, etc. are provided at the scattering position, so that the cut skins a2 may be dropped to a predetermined position inside the frame F.

The preparation device 3 will now be explained. The preparation device 3 is continuously connected to the feeding mouth of the shaping device body 2, and is chiefly comprising, the receive cylinder 4 which supports one process subject article A by a process start end 40 that is an upper end thereof, a feeding cutter blade unit 5 provided with a feeding cutter blade 50, having substantially the same shape as the inner shape of the receive cylinder 4 and capable of being inserted in the receive cylinder 4, and a mounting device 6 which places the process subject article A at predetermined intervals on the receive cylinder 4.

The above chief components will now be explained in detail.

First, the receive cylinder 4 will be explained. The receive cylinder 4 has a cylindrical shape, and is set, for example, substantially in a vertical state, and is connected to the receive cylinder 4 of the shaping device body 2 via the connecting chute 43. There is a V-shape groove 40a, provided in the top of the process start end 40 of the receive cylinder 4, in the orthogonal direction of the feeding direction of the process subject articles A, so that the fed process subject articles A may be stored easily at the process start end 40 of the receive cylinder 4. The receive cylinder 4 also has two slits 41 in the vertical direction, so that supporting rods 61 of the mounting device 6 (explained afterwards) may be escaped without collision. The side surface of the receive cylinder 4 is also provided with a flat-shape discharge guide 42, serving to discharge the cut chips a1 cut by the feeding cutter blade 50, which is continuously connected to a collecting tank (not shown).

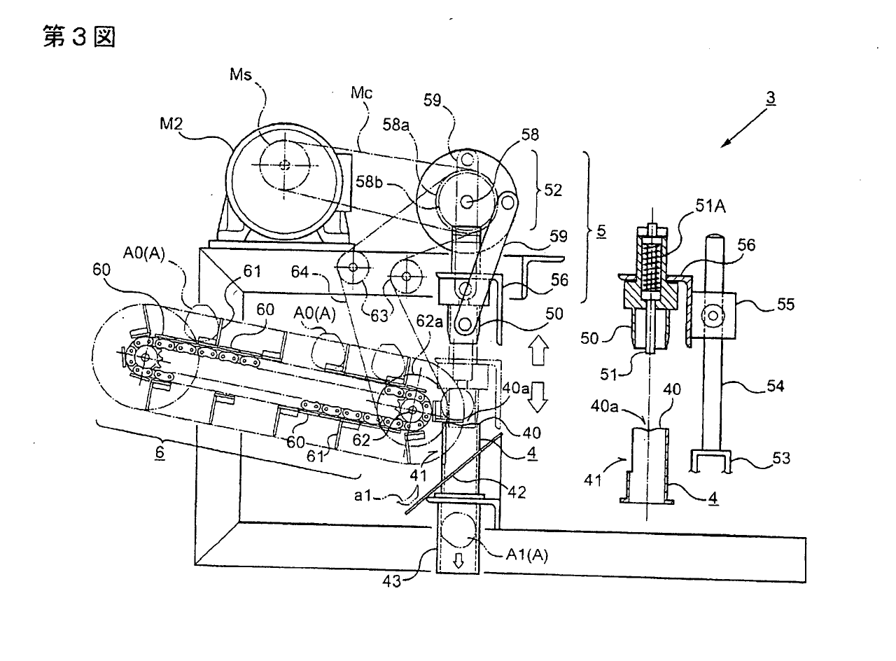

The feeding cutter blade unit 5 will now be explained. The feeding cutter blade unit 5 chiefly comprises the feeding cutter blade 50 substantially in a cylindrical shape, and the feeding cutter blade 50 makes the reciprocating motion in the upward and downward directions by a slider crank mechanism 52. As illustrated in the sectional view of FIG. 3, there is a pushing rod 51, substantially at the center of the feeding cutter blade 50, which may move both in the upward and downward directions. There is a compression coil spring 51A, which applies the force to the pushing rod 51 in the downward direction. The pushing rod 51 is also provided with a stopper by which the downward motion is prohibited at a predetermined position.

The slider crank mechanism 52 will be explained. There is a guide rod 54 standing on a mounting block 53, penetrating through a slider 55, so that the slider 55 may move in the upward and downward directions. The slide 55 and the feeding cutter blade 50 are connected by a connecting arm 56. As illustrated in FIGS. 2 and 3, the mounting block 53 has a crank wheel 57 which may rotate by a center shaft 58, and an end of a crank rod 59 is rotatively connected to the side rim surface thereof. Another end of the crank rod 59 is rotatively connected to the slider 55. There is a driven sprocket 58a at the center shaft 58 of the crank wheel 57, and there is also a drive sprocket Ms provided on a drive shaft of a drive motor M2 positioned above the driven sprocket 58a. The driven sprocket 58a and the drive sprocket Ms are connected by a chain Mc, so that the rotative motion of the drive sprocket Ms is transmitted to the driven sprocket 58a.

The mounting device 6 will be explained. As the mounting device 6, for example, a slat conveyor, of which feeding surface is somewhat inclined downwardly toward the receive cylinder 4, is used. There is a pair of support rods 61 on the right and left, substantially standing perpendicularly from the upper surface of a slat 60, at predetermined intervals, so that the process subject articles A on the slat 60 may be supported.

The slat conveyor is also driven by the drive motor M2. There is a connecting sprocket 58b at the center shaft 58 of the crank wheel 57, and a chain 64 is wound around a sprocket 62a provided on a drive shaft 62 of the slat conveyor, through a connecting sprocket 63 separately provided on the frame F, thus the rotative motion of the drive motor M2 is transmitted.

The foodstuff shaping device 1 according to the present invention has the structural examples as discussed above. Now the manner of operation thereof will be discussed as below.

(1) Mounting of the Process Subject Articles on the Receive Cylinder:

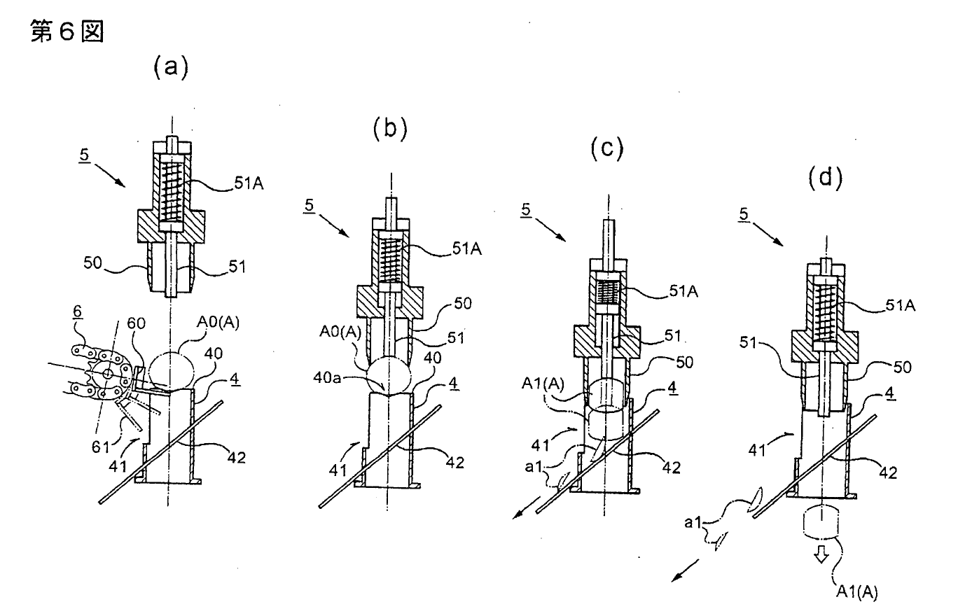

First, the motion of the preparation device 3 will be explained. For example, process subject articles A0, which are before process application, are placed on the slat 60 by manual operation, so that they are supported by the support rods 61 of the mounting device 6. As the feeding surface is inclined downwardly toward the receive cylinder 4, the placed process subject articles A0 are transmitted to the receive cylinder 4, supported by the support rods 61. As illustrated in FIG. 6(a), at the end of the mounting device 6, the support rods 61 pass through the slits 41 of the receive cylinder 4, by supporting the process subject articles A0. Therefore, if the supported process subject article A0 cannot pass through the receive cylinder 4, the process subject article A0 will be placed on the process start end 40 at the top of the receive cylinder 4. With reference to the process subject articles A0 placed according to the intervals of the supporting rods 61, as an example, the speed of the mounting device 6 is set so that one process subject article A0 is placed on the receive cylinder 4 every three seconds. Accordingly, the process subject articles A1 after preparation may be fed to the shaping device body 2 every three seconds, thus there is no possibility of excessive feeding, and there is almost no possibility of the process subject articles A2 being blocked during shaping process in the shaping device body 2.

(2) Preparation before Cutting by the Feeding Cutter Blade:

At the timing when the process subject article A0 is placed on the receive cylinder 4 and the support rods 61 escape downwardly, as illustrated in FIG. 6(b), the feeding cutter blade 50 goes down by the slider crank mechanism 52, and cuts the process subject article A0 to be in the shape suitable for shaping by the shaping device body 2. At that time, the pushing rod 51 at the center of the feeding cutter blade 50 becomes in touch with the upper surface of the process subject article A0, and remains there, but the compression of the compression coil spring 51A is still continued. Thereafter, as illustrated in FIG. 6(c), the feeding cutter blade 50 reaches the lower dead center, where the process subject article A0 after preparation has been cut completely. As the process subject article A0 has no stopper against going out of the receive cylinder 4, as illustrated in FIG. 6(d), the compressed force of the compression coil spring 51A presses the pushing rod 51 in the downward direction, and the process subject article A1 is dropped into the receive cylinder 4. The cut chips a1 cut by the feeding cutter blade 50 then go through the discharge guide 42, and are collected by the collecting tank provided appropriately.

(3) Receiving of the Process Subject Articles in the Shaping Device Body:

With reference to the shaping device body 2, a drive motor M1 is driven by providing an appropriate power supply circuit, whereby the blade unit 11 remains the rotative motion. It is difficult to determine the experimental value by the inventors of the present invention, and it depends on the characteristic of the process subject article A. However, for example, if aroids are subject of shaping, provided that the diameter of the rotative drum 14 is about 300 mm, the rotative speed may be between 500 and 1500 rpm, preferably at 1000 rpm.

The process subject article A1 after preparation by the preparation device 3 is dropped, by its own weight, through the feeding mouth 22, into the process room 21, formed by the space between the outer periphery recessed part 14A of the rotative drum 14 of the blade unit 11 and the inner side surface of the feeding guide unit 12. At that time, because the feeding guide unit 12 is provided with blocker plate 25 below the feeding mouth 22, the process subject article A1 is accelerated and guided to the process room 21, just like the process subject article A1 is riding on a chute. Therefore, even when any effect by the cutter blades 15 is given to the dropped process subject article A1, it will not be transmitted to any deviated position toward the movement direction of the cutter blades 15 by exceeding the top of the process room 21. The diameter of the process room 21 just allows the passing of one process subject article A1, and the feeding from the preparation device is done at predetermined intervals (for example, according to the present embodiment, 1 piece per 3 sec.), there is almost no possibility that several process subject articles A1 might become obstacles to the shaping process of the other process subject articles with each other. Thus, it is possible to obtain the process subject articles A3, each of which finish is almost desired uniformed shaping. The desired uniformed shaping finish of the process subject articles A3 and the eject thereof are done continuously, by using the natural drop of the process subject articles A, without any intermediate stop of the device. Therefore, the workability is remarkably excellent.

(4) Cutting of the Process Subject Articles:

(4)-i Floating State During Shaping Process:

With reference to the feature of the process of the process subject articles A1 fed in the process room 21, although there is a restriction that the process subject article A2 itself is held inside the process room 21, it may be mentioned that there is substantially no forced holding, and it may be in a sufficient floating state inside the process room. The “floating state” means the existence of free state for changing the position of the process subject article A2, when the process subject article A2 is cut by substantial collision with the cutter blades 15 of the blade unit 11. According to the characteristic of the process subject article A2, as long as the motion thereof is allowed, it is possible, for example, that the process subject article A may be somewhat pressed toward the blade unit 11 by the force applied by the feeding guide unit 12.

(4)-ii Cutting of the Side Peripheral Parts:

When the process subject article A is fed as discussed above, as illustrated in FIGS. 7(a) and 7(b), as the size is rather large, due to the effective blade shape of the cutter blades 15, which is substantially in the shape of U or V opening in the upward direction, the floating state of the bottom thereof is maintained, and the side peripheral surfaces thereof become in contact with the cutter blade chips 15A, 15B on the right and left alternatively, and the cutting is done in the respective side effective portions Z1. As illustrated in FIGS. 7(a) and 7(b), when providing imaginary axes C1, C2, substantially elongating in the diameter direction of the process subject article A2 during shaping, the cutting is done by the cutter blade chip 15A in FIG. 7(a), and at the moment when the side effective portion Z1 of the cutter blade chip 15A becomes in contact with the process subject article A2, the surface of the process subject article A2 is cut, and at the same time, the rotative motion in the counterclockwise direction of FIG. 7(a) is generated for the process subject article A2, around the imaginary axis C1. Thereafter, as illustrated in FIG. 7(b), according to the rotation of the rotative drum 14, when the cutter blade chip 15B on the other side becomes in contact with the process subject article A2 during shaping, the surface of the process subject article A2 is cut similarly in the side effective portion Z1, and the rotative motion in the clockwise direction of FIG. 7(b) is generated around the imaginary axis C2. These cutting procedures are repeated, and it is understood that, in the process room 21, the cutting is first done in the side effective portions Z1 of the cutter blades 15, on the side surfaces on the right and left of the process subject article A2 during shaping.

(4)-iii Cutting of the Bottom:

Through the above cutting process, the side diameter of the process subject article A2 during shaping becomes smaller. Accordingly, as illustrated in FIG. 7(c), the bottom of the process subject article A2 becomes in contact with the bottom effective portions Z2. The bottom effective portions Z2 are formed by the respective cutter blade chips 15A, 15B, and the cutting is done to the bottom of the process subject article A2 during shaping, being in contact with these portions Z2. Every time when the process subject article A2 becomes in contact with the bottom effective portions Z2 of the cutter blade chips 15A, 15B, the rotative motion is given, around an imaginary axis C3 serving as the axis of the process subject article A2, in the direction opposite to the rotative direction of the rotative drum 14, of which axis is parallel to the axis C3. When such a rotative motion is given, for example, it is possible that the process subject article A2 during shaping becomes upside down. In this case, if there are any portions which are not in contact with the side effective portions Z1, i.e. any portions remaining as the larger diameter, these portions will become in contact again with the side effective portions Z1 of the cutter blade chips 15A, 15B on the right and left, and become in the state that the bottom is floated, and the side surfaces will be cut again by the side effective portions Z1 according to the function as discussed above. Thereafter, the process subject article A2 during shaping becomes in contact again with the bottom effective potions Z2, and rotates around the above axis C3, as if it were rolling along the outer periphery of the rotative drum 14 inside the process room 21. Thus, the skins a of the process subject article A2 are cut thoroughly, and the shape becomes much more spherical.

It is of course understood that the above function has been imagined under analysis, and with reference to the actual motion, because the process subject article A2 is freely moving inside the process room 21, it will not be always true that the process is done in the above order systematically, and it is assumed that the cutting is done suitably according to the characteristics of the respective process subject articles A2. However, as a result, the process subject articles A3 after shaping are discharged, all substantially in a spherical shape. For reference, it is assumed that the finish diameter of the process subject articles A3 after shaping is substantially determined by the diameter of the outlet 24 of the process room 21. When the above shaping is done, it is needless to say that the process subject article A is brought into contact with the cutter blades 15, and in addition, the process subject article A is also in contact with the inner surface of the guide trough 20. Therefore, if the inner surface of the guide trough 20 has a polishable structure like a sanding machine, the polishing of the surface can be done at the same time.

(5) Discharge of the Cut Skins:

When the shaping is continuously done, it is needless to say, the skins a of the process subject article A1 are cut, and the cut skins a2 are generated. If these cut skins a2 are left without taking any disposal, they will cause so-called contamination in the process room 21 or the cutter blades 15, which would become a potential obstacle to the smooth cutting. This tendency is significant, if the process subject article A is aroid, etc., i.e. the food material originally having viscous liquid. Therefore, according to the present invention, during shaping, the cut skins a2, which have been cut by contact with the cutter blades 15, go into the escape spaces 18 for the cut skins a2, substantially formed by the cutter blade receiving parts 16, whereby the removal of the skins a can be always done smoothly. The escape space 18 as a whole has substantially a whirling shape, inclined toward the center. Thus, the cut skins a2 will move toward the bottom parts of the escape spaces 18, and reach the remaining chips discharge pockets 19 continuously connected to the bottom parts, instead of being thrown normally, by centrifugal force in the centrifugal direction. As these spaces are rather wide, the cut chips a2 reached there may move rather freely inside the remaining chips discharge pockets 19, and are not bound there. Consequently, the cut chips a2 will go out of side surface thereof, by centrifugal force due to the rotation of the blade unit 11. At that time, as illustrated in FIG. 7(d), the cut skins a2 collide with the discharge guide surface 14C provided on the outer periphery of the thin part 14B of the rotative drum 14, and go outside. Consequently, the cut skins a2 may be discharged in the downward direction effectively.

### Other Embodiments

The above discussed is a basic embodiment of the present invention. However, it is of course possible to provide various alternations or modifications as below:

(6) Modification of the Preparation Device:

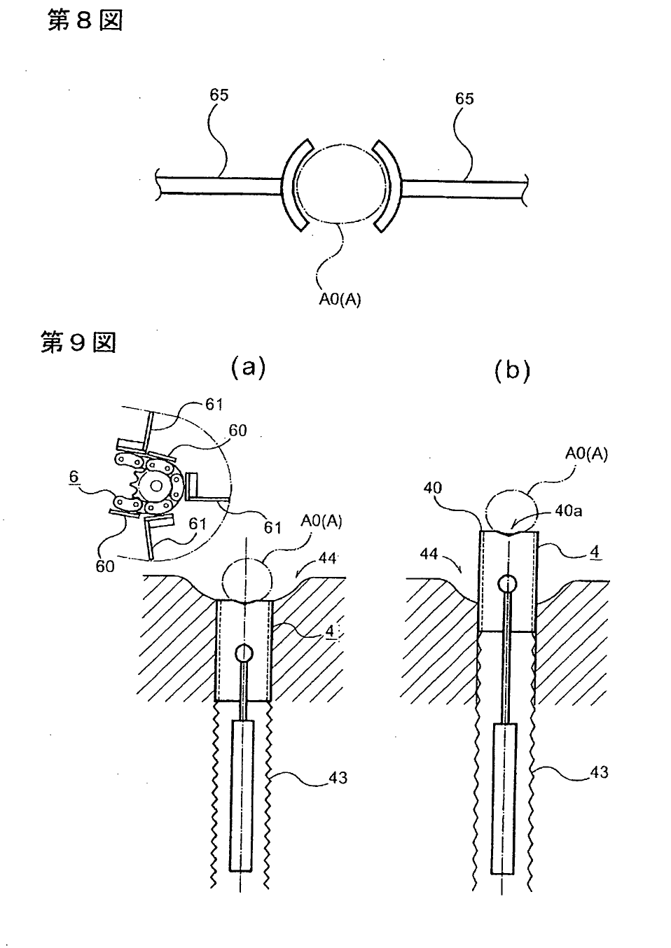

With reference to the mounting device 6, the example has been described in the case of using the slat conveyor, and the support rods 61 are provided substantially in the vertical state on the upper surface of the feeding surface. However, as illustrated in FIG. 8, it is also possible to hold the process subject article A0 by a robot arm 65, and the process subject article A0 is placed on the upper surface of the receive cylinder 4 by the robot arm 65.

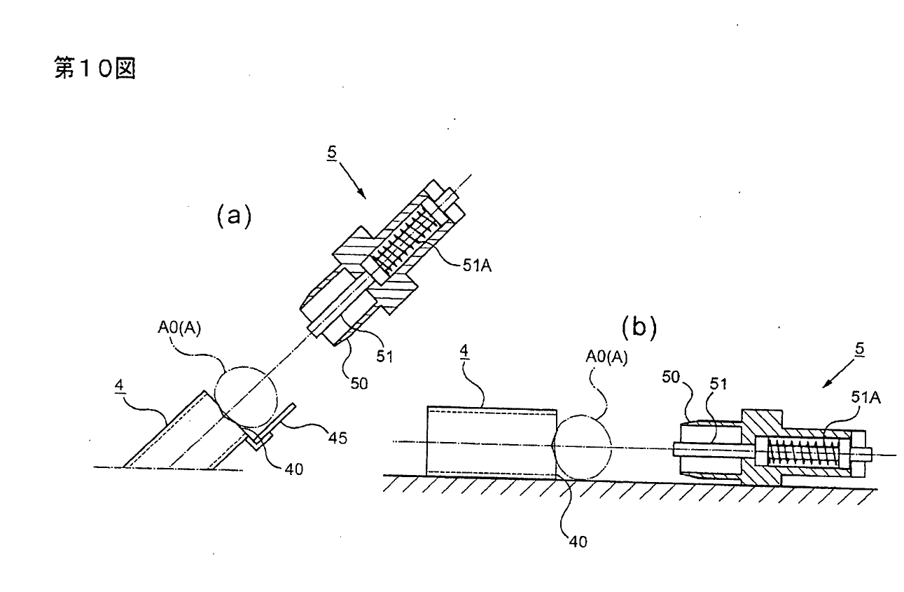

Further, as illustrated in FIG. 9, the receive cylinder 4 may move in the upward and downward directions at the center of a bowl-shape recessed part 44, and when the process subject article is received, as illustrated in FIG. 9(a), the receive cylinder 4 receives the process subject article by going down in the downward direction of the recessed part 44, and after receiving, as illustrated in FIG. 9(b), the receive cylinder 4 goes up. For reference an extendable accordion pipe is used as the connecting chute 43.

According to the above embodiment, the drive motor M1 of the shaping device body 2 and the drive motor M2 of the preparation device 3 are separately provided. However, it is also possible to use a common drive motor, whereby the blade unit 11, the feeding cutter blade 50 and the mounting device 6 are driven by appropriate power transmission mechanisms.

Further, although the slider crank mechanism 52 is disclosed as the mechanism for moving the feeding cutter blade 50 in the upward and downward directions, it is also possible to provide an air cylinder, etc., for moving the slider 55 in the upward and downward directions.

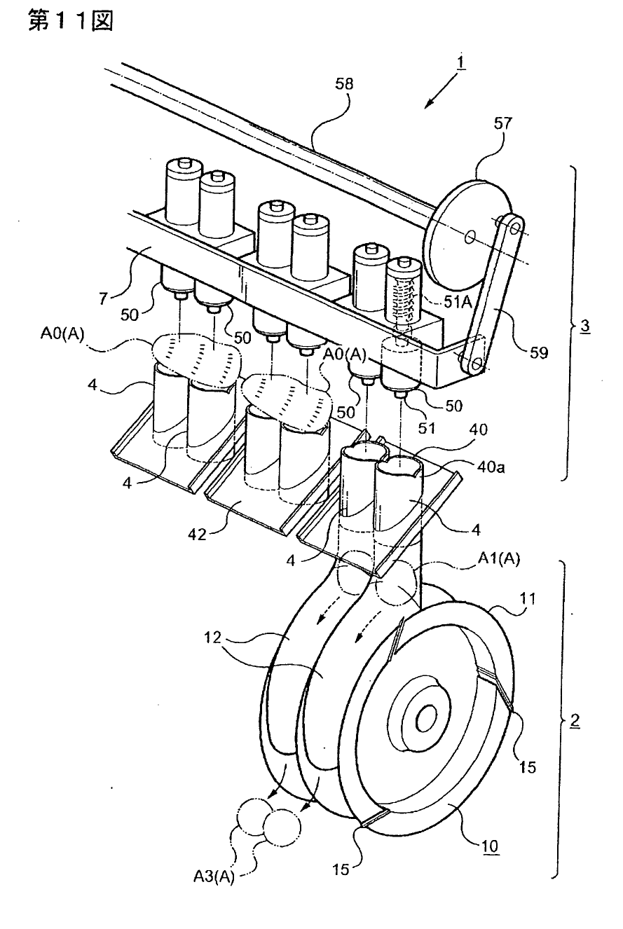

According to the basic embodiment as discussed above, as an example, the receive cylinder 4 is set in the vertical state, of which top serves as the process start end 40. However, as illustrated in FIG. 10(a), it is also possible to provide the receive cylinder 4 in the inclined state, or as illustrated in FIG. 10(b), it is also possible to provide the receive cylinder 4 in the horizontal state. It is to be noted that reference numeral 45 in FIG. 10(a) shows a guard plate, which prevents the drop of the process subject article A0 placed on the process start end 40.

When the shaping of rather larger size of the process subject article A, such as aroid, is done, it is possible to use a plurality of the feeding cutter blades 50 (two, three, etc.), adjacent to each other.

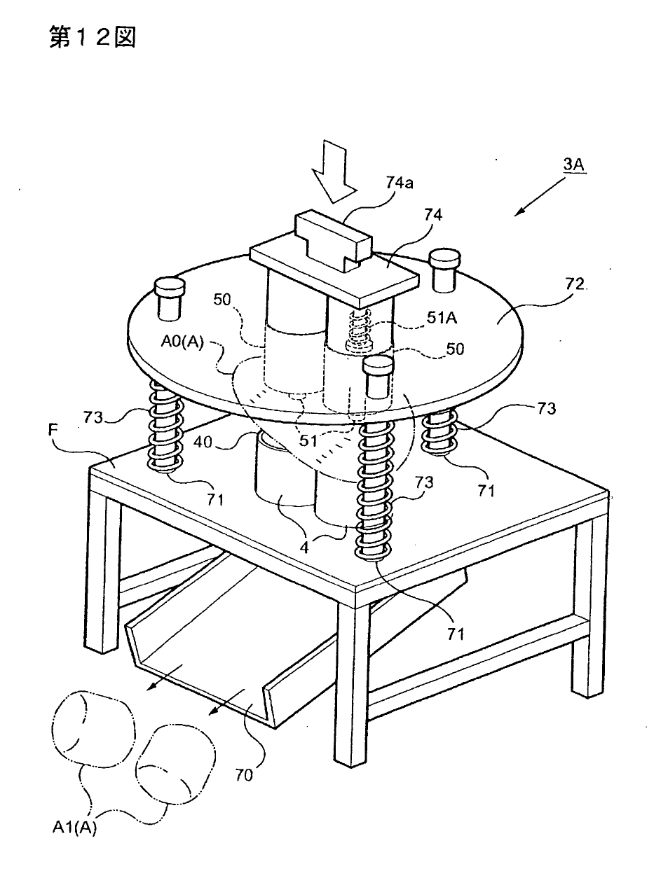

For reference, as illustrated in FIG. 11, the preparation device 3 of the foodstuff shaping device 1 has a plurality of the feeding cutter blades 50, each pair of which is adjacent to each other, connected by a connecting plate 7. There is also a plurality of the receive cylinders 4, each pair of which is adjacent to each other, corresponding to the feeding cutter blades 50 adjacent to each other. The other structure is substantially the same as the basic embodiment as discussed above, and it is also possible to apply appropriate modification thereto, disclosed in other embodiments.

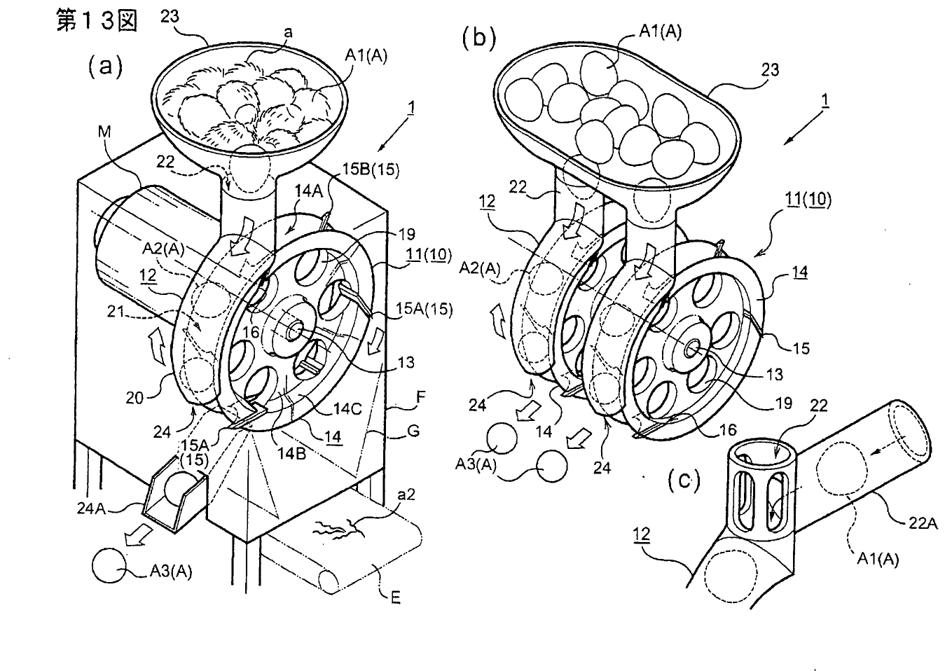

The technical concept of the preparation device as disclosed in FIG. 11 may also provide, according to the characteristic of the process subject article A, for example a manual-operation independent type of preparation device 3A, having a plurality of the feeding cutter blades 50, several pieces of which are continuously connected to each other, as illustrated in FIG. 12. With reference to the preparation device 3A as shown in FIG. 12, there are two receive cylinders 4 adjacent to each other, substantially at the center of the rectangular-table shape of the frame F, having a flat panel covering the upper surface of the frame F. The each bottom of the receive cylinder 4 penetrates through the upper surface of the frame F, facing to an ejector chute 70 provided below. There are guide rods 71 standing on the right and left of the upper surface of the frame F, to which a lifting frame 72 is placed to be movable in the upward and downward directions. There are compression coil springs 73, applying force to the lifting frame 72 in the upward direction. There are two feeding cutter blades 50, fixed on the lifting frame 72, in the state that the bottom of each feeding cutter blade 50 is protruding from the bottom surface of the lifting frame 72. The each top of the feeding cutter blade 50 is fixed by a connecting plate 74, and a handle 74a is provided on the upper surface of the connecting plate 74. There are pushing rods 51 respectively incorporated in the feeding cutter blades 50, to which the downward force as disclosed in the basic embodiment has been applied.

When the preparation device 3A as discussed above is used, at the first step, each feeding cutter blades 50 is at the higher position due to the force applied by the compression coil spring 73. In such a state, the process subject article A0 before shaping is placed. Thereafter, the handle 7a is held, and pressed downwardly, so that the feeding cutter blades 50 may cut the process subject article A0 before shaping. Thus the process subject article A1 is cut and the preparation is done, and the process subject article A1 is dropped inside the receive cylinder 4, and ejected upon reaching the ejector chute 70. When the lifting frame 72 becomes in touch with the receive cylinders 4, the downward motion of the feeding cutter blades 50 are stopped.

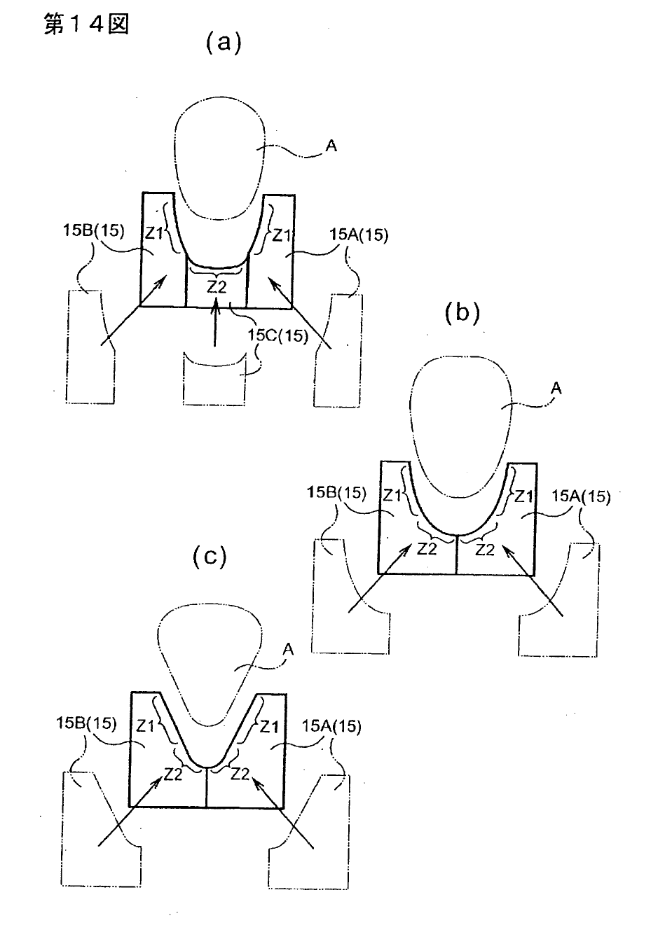

It is also possible to provide the foodstuff shaping device 1 according to the present invention, substantially solely by the shaping device body 2. For example, as illustrated in FIGS. 13(a) and 13(b), it is possible to provide a modification, in which, a feeding hopper 23 is connected to the feeding mouth 22 of the guide trough 20, so that the process subject article A1, to which the preparation by appropriate method has been done, may be fed into the feeding hopper 23. For reference, according to the foodstuff shaping device 1 of FIG. 13(a), it is also disclosed an example in which the cut chips a1 are transmitted by a conveyor E. As discussed above, when the process subject articles A1 are fed by the feeding hopper 23, for example, as illustrated separately in FIG. 13(c), it is preferable to provide a basket-shape pipe of feeding mouth 22, having a diameter which allows the receiving of one process subject article A each time. There is an inclined feeding pipe 22A, following the feeding hopper 23 not shown), having a connected passage to the side surface of the feeding mouth 22, so that the exact one process subject article A is dropped every time. According to this embodiment, although there is a possibility that the cut skins a2 might reach even this portion, because the feeding mouth 22 is the basket-shape pipe, the cut skins a2 may be removed, or the adhesion thereof may be prevented as mush as possible.

(7) Modification of the Shaping Device Body:

(7)-i Modification Examples of the Blade Unit:

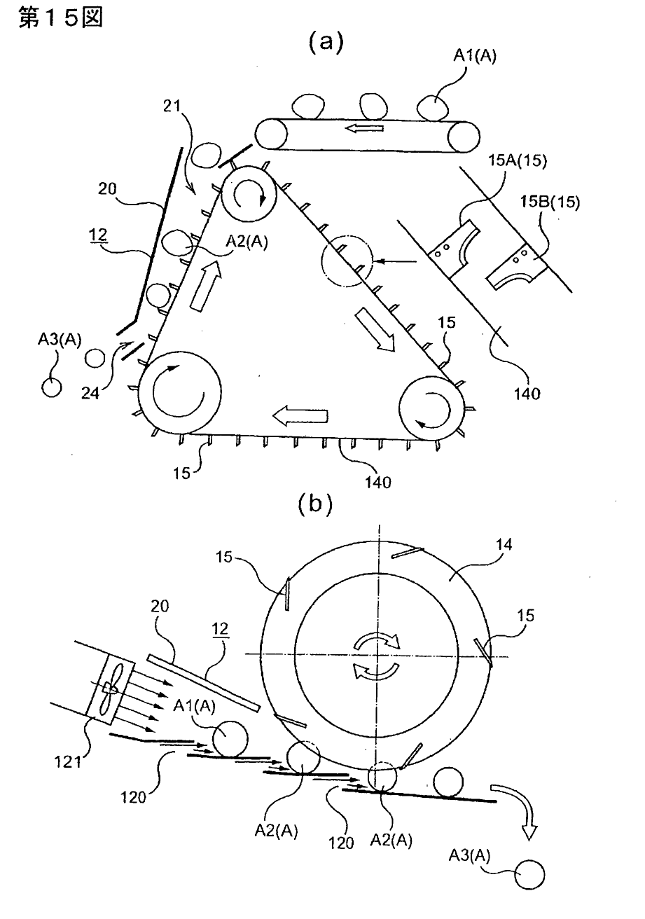

The blade unit 11 may be modified, as to the shape of the cutter blade 15 itself, or the basic structure of the blade unit 11. First, with reference to FIG. 14(a), the cutter blade chips 15A, 15B respectively have the function only as the side effective portions Z1, and another cutter blade chip 15C is provided serving for the bottom effective portion Z2. Further, FIG. 14(b) illustrates a modification example of the cutter blades 15 of the blade unit 11, to which the rotative drum 14 is applied. According to the finished shape, for example, the overall combined effective blade may be in the U-letter shape, and in particular, the bottom effective portions Z2 may be in the non-overlapping shape. In this case, it is experimentally understood that the part of the process subject article A would become in the shape of spindle or circular cone. It is also possible to provide the V-shape structure as illustrated in FIG. 14(c), in order to facilitate the above tendency.

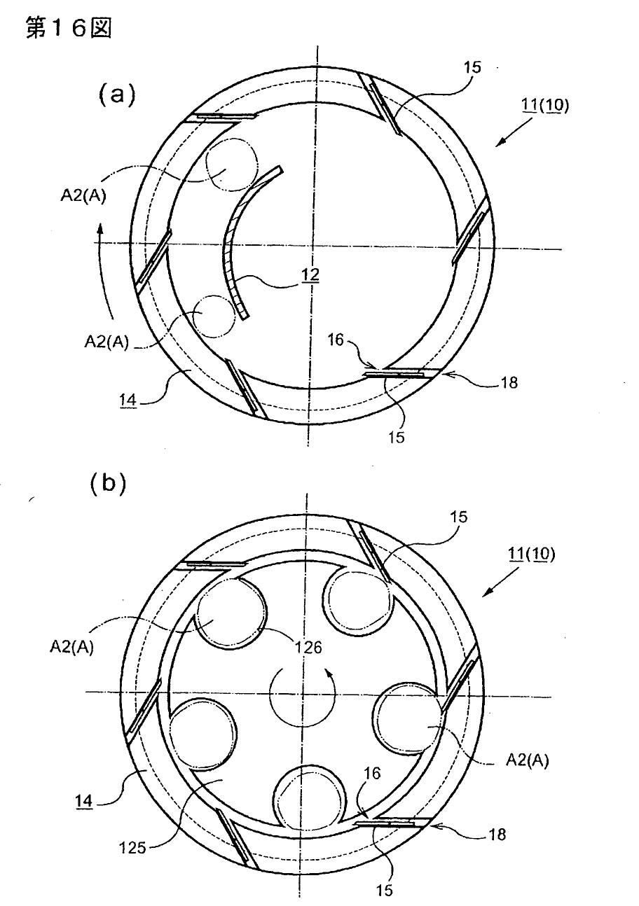

According to the basic embodiment, the cutter blades 15 are provided on the peripheral surface of the rotative drum 14. However, the position is not limited to this embodiment, as long as the relative motion between the process subject article A and the cutter blades 15 is secured, and it is not necessary that the rotative blade unit 11 should have a circular, rotative tracking. For example, as illustrated in FIG. 15(a), there is a belt base member 140 having a sufficient strength to support the cutter blades 15, on which the cutter blades 15 have been planted. The feeding guide unit 12 may be provided along the outer periphery of the track thereof, at which part the process room 21 is formed. According to this structure, the inclined angle of the process room 21 may be changed, for example, by adjusting the inclined angle of the blade unit 11 as a whole, comprising the belt base member 140, whereby the feeding speed of the process subject articles A may be adjusted appropriately.

(7)-ii Modification Examples of Feeding Method:

With reference to the feeding of the process subject articles A, according to the basic embodiment, or according to the embodiment as illustrated in FIG. 15(a) in which the cutter blades 15 of the blade unit 11 are planted on the belt base member 140, the transmission of the process subject articles A is basically done by using natural drop. On the other hand, as illustrated in FIG. 15(b), it is also possible to move the process subject articles A positively, through application of fluid effect of air or water to the process subject articles A, by using nozzles 120 or a fan 121.

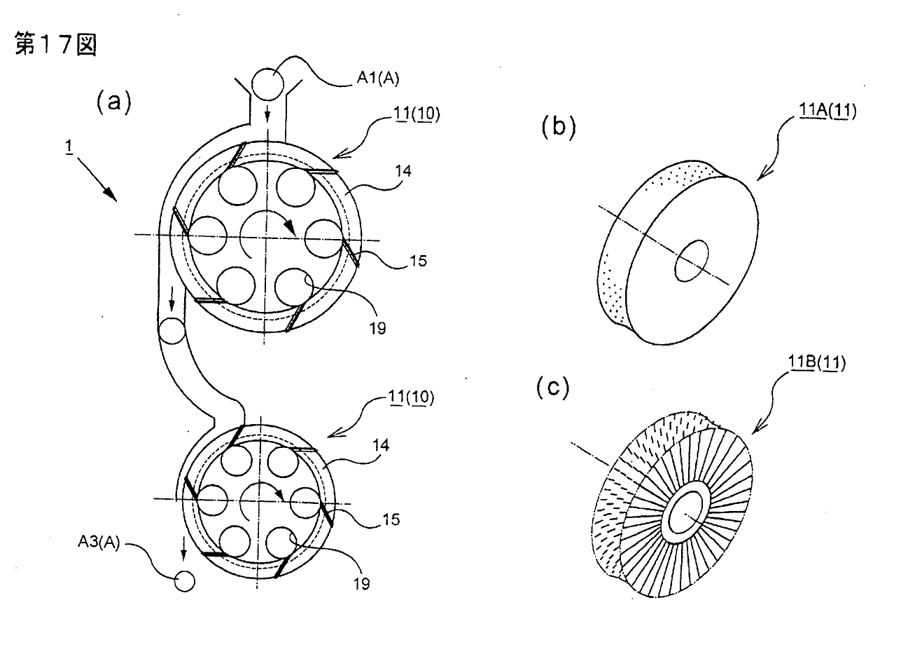

According to each embodiment as discussed above, with reference to the relative motion between the cutter blades 15 and the process subject article A, the process subject article A is moved, by contact of the cutter blades 15 of the blade unit 11 with the process subject article A, on the outer periphery of the blade unit 11. However, it is also possible to move and shape the process subject article A, as illustrated in FIG. 16(b), in a state that the inner periphery of the blade unit 11 becomes in contact with the process subject article A. In this case, there is a ring-shape blade unit 11, and the cutter blades 15 are attached to the inner periphery of the blade unit 11, and the feeding guide unit 12 is also provided along the inner periphery of the blade unit 11, thus the shaping is done. Further, as illustrated in FIG. 16(b), there is a holding rotative drum 125 provided inside the blade unit 11 for holding the process subject articles A, having holding pockets 126 for holding the process subject articles A. When this holding rotative drum 125 is rotated, as an extreme example, it is almost possible to carry out the shaping without rotating the blade unit 11.

(7)-iii Multi-Stage Structure:

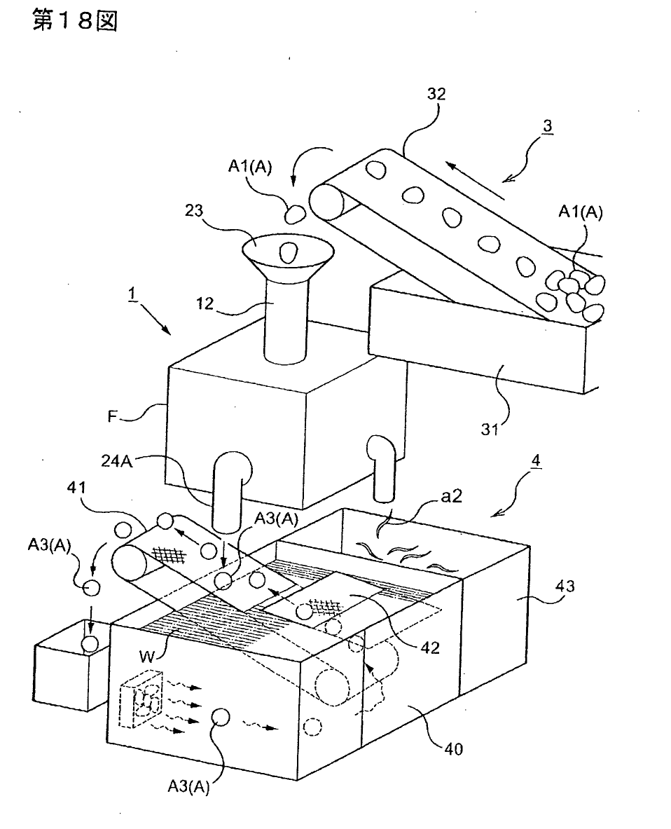

For the purpose of improving the workability or shaping accuracy, it is also possible, as illustrated in FIG. 17(a), to provide the process heads 10 in series. In this case, for example, the rough shaping may be done in the former stage, and the finish shaping may be done by the process head 10 in the latter stage. With reference to the finish shaping, as illustrated in FIGS. 17(b) and 17(c), it is also possible to use a sanding disk 11A or a brush roll 11B substantially in the same shape as that of the blade unit 11, whereby the finished surface may become more accurate.

(7)-iv Auxiliary Devices:

With reference to the foodstuff shaping device 1 according to the present invention, the discharge and washing after shaping may be done at another place independently, but it is also possible to combine these functions with the present device. As illustrated in FIG. 18, there is a feeding device 8 before the foodstuff shaping device 1, and there is also a take-out washing device 9 after the foodstuff shaping device 1. With reference to the feeding device 8, there is a hopper 31, and a feeding conveyor 32 of which feeding start end is going inside of the hopper 31. Thus, the process subject articles A1 are picked up one after another, and dropped into the feeding hopper 23 above the feeding guide unit 12.

After the foodstuff shaping device 1, there may be a washing tank 40 which washes the process subject articles A3 after shaping, and a take-out conveyor 41, which moves the process subject articles A3 one after another, of which shaping and washing have been completed, and for example, which further carries out the finishing of the surface. For example, the surface of the take-out conveyor 41 may be like a sanding machine, and a guide panel 42 may be provided along the upward track of the take-out conveyor 41, so that the upper part of each process subject article A may be pressed by the guide panel 42. Consequently, when the process subject articles A are transmitted, because of the surface of the take-out conveyor 41, which is like a sanding-machine, the surface of the process subject article A is polished, and the smooth surface may be obtained. This function is done, of course, during passing through the washing tank 40, and there may be slight cut chips generated through finishing, these cut chips can be washed by washing water W inside the washing tank 40. There may be a collecting tank 43 on the side of the washing tank 40, in order to collect the cut chips a1.

(7)-v Safety Measures:

As the present device has cutter blades, it is possible to provide a safety device, according to which, when the frame F is removed for inside inspection, the removal is detected, and the operation may be stopped in order to avoid any accident.

(7)-vi Measures Against Contamination:

According to the present invention, due to the cut skins a1, there will be a risk of contamination around the cutter blades 15 or inside the process room 21. Thus, as discussed above, such a risk may be avoided by providing the escape spaces 18 or the remaining chips discharge pockets 19 for the cut chips a1. Further, as another measure, although it is not illustrated by drawing, the blade unit 11 and the feeding guide unit 12 are totally dipped in the washing water W, etc., so that the washing is always done positively during shaping. It is of course possible to blow the washing water W separately to the position at which there is a high risk that the cut skins a1 would become blocking obstacles.

(7)-vii Examples of Application to Other Process Subject Articles:

As the substantial technical problem has been the providing of a novel shaping of aroids, etc., the present invention discloses an embodiment that is mostly suitable for that problem. However, as long as the similar process is required, the present invention may also be applied to the shaping of other appropriate subjects, such as the shaping of vegetables, edible roots, etc. For example, when the shaping of frozen semi-processed foods, having a predetermined hardness, is required, or when the post-process shaping of fish cakes, etc., is required, or when the further shaping of the frozen fish fleshy mass, to be in the shape of ball, such as the spherical shape, is required in order to give variation as foodstuff, or when the shaping of ice for drinks to be in the spherical shape is required, and further, even apart from foods, when the post-process shaping of irregular-shape products such as rubber, resin, etc., is required, the present invention may be applied.

The present invention has the technical features as discussed above, with the following effects. First, according to the invention as claimed in claim 1 or 6, when the process subject article A is faced to the cutter blades 15, as the floating state is maintained, the process subject article A becomes in contact with the cutter blades 15 and the surface thereof is cut, and at the same time, the cutter blades somewhat give the floating state or rotative state continuously, whereby the surface is cut uniformly and for example to be a desired spherical shape. Thus, the process by simple structure and at lower cost can be secured.

According to the invention as claimed in claim 2 or 8, the cutter blades 15 have the rotative tracking. Thus, it is possible to provide a reasonable layout of the relative process area between the cutter blades 15 and the process subject articles A.

According to the invention as claimed in claim 3 or 9, the cutter blades 15 have the combined effective blade shape of the letter U. Thus, even if the initial shape of the process subject articles A is not spherical, it is possible to finish them in the spherical shape.

According to the invention as claimed in claim 4 or 10, the relative movement is done, by rotating the rotative drum 14 provided with the cutter blades 15, and through natural drop of the process subject articles A in the process room 21. Thus, the shaping can be done without requiring any special measure for facilitating the movement of the process subject articles A.

According to the invention as claimed in claim 5 or 11, the rotative drum rotates substantially in the perpendicular direction, having the cutter blades on the outer periphery, and the outer periphery of the rotative drum is covered by the feeding guide unit, in order to form the process room 21 having the passage space which allows passing of one process subject article. Thus, since the shaping can be done, by using natural drop of the process subject article A, continuously without requiring any special intermediate stop of the device, the workability is excellent. Further, as the process room 21 has the passage space which substantially allows the passing of one process subject article A1, there is no possibility that several process subject articles A2 might become obstacles to the shaping process of the other process subject articles with each other. Thus, it is possible to obtain the process subject articles A, each of which finish is almost desired uniformed shaping.

According to the invention as claimed in claim 6 or 12, it is possible to discharge the cut skins a1, etc., smoothly, whereby the stable continuous operation can be done. According to the invention as claimed in claim 13, the preparation device 3 cuts the process subject articles A in advance to be in a predetermined shape so that the shaping process can be done easily, and then fed to the shaping device body 2 at predetermined intervals. Thus, there is almost no possibility of the process subject articles A being blocked during shaping process in the shaping device body 2. Further, it is not necessary to provide a cutting device (crude processing device) other than the device for shaping foodstuffs and the like 1, and it is also not necessary to provide a conveyor connecting between a cutting device and the shaping device, unlike the prior art. Because the overall structure of the device is not a production-line type, the overall size of the device may become smaller, thus the device may be placed almost anywhere, even in a narrow space.

According to the invention as claimed in claim 14, the feeding cutter blade 50 is provided, at the center thereof, with the pushing rod 51 movable in the forward and rearward directions toward the receive cylinder 4, and with the force applying member, which applies force to the pushing rod 51 toward the inside of said receive cylinder 4. Thus, after the cutting of the process subject article A0 by the feeding cutter blade 50, the process subject article A1 is pushed by the pushing rod 51, and dropped into the receive cylinder 4 smoothly.

According to the invention as claimed in claim 15, the receive cylinder 4 is provided substantially in the vertical state. Thus, the process subject article A1 after preparation is dropped smoothly, by natural drop, into the feeding mouth 22 of the shaping device body 2. Further, the V-shape groove 40a is formed in the top of the process start end 40. Thus, the placing stability of the process subject article A0 when being placed thereon is good, and there is no risk that the process subject article A0 might fall down from the process start end 40 of the receive cylinder 4, and there is also very little risk of wrong mounting by the mounting device 6.

According to the invention as claimed in claim 16, the mounting device 6 is provided with the support rods 61 for supporting the process subject articles on the feeding surface of the slat conveyor, and the slits 41 are formed in the vertical direction in the receive cylinder 4 in order to avoid collision of the cylinder with the support rods 61. Thus, the mounting device 6 may have a simple structure, and the production cost thereof may be reduced. Further, because of the structure by the support rods 61 and the slits 41, the process subject articles A0 may be placed on the process start end 40 of the receive cylinder 4 without any giving any impact, whereby the wrong mounting can be avoided remarkably. As the slat conveyor has the good rigidity, the support rods 61 surely support the process subject articles A0 even at the feeding end.

According to the invention as claimed in 17, it is possible to provide products to market, which have been shaped to be in a desired shape.

According to the invention as claimed in claim 18, the process subject articles are aroids, which have been considered as difficult materials for shaping. However, it is possible to obtain these products in a desired shape, by reasonable, efficient and cost-reducing shaping.

### INDUSTRIAL APPLICABILITY

As above discussed, the present invention is suitable for improving workability and cost-effectiveness, when shaping process subject articles such as aroid or taro.

1. A method for shaping foodstuffs and the like, by applying cutter blades (15) to process subject articles (A) in order to shape a surface of each of said process subject articles (A), characterized in that:
said process subject articles (A) and said cutter blades (15) are relatively moved, and said process subject articles (A) can be held in a floating state when said cutter blades (15) are applied to said process subject articles (A).

2. The method for shaping foodstuffs and the like as claimed in claim 1, further characterized in that:
said cutter blades (15) have a rotative tracking.

3. The method for shaping foodstuffs and the like as claimed in claim 1, further characterized in that:
said cutter blades (15) have a combined effective blade shape of a letter U.

4. The method for shaping foodstuffs and the like as claimed in claim 1, further characterized in that:
said relative movement is done by rotating a rotative drum (14) provided with said cutter blades (15), and through natural drop of said process subject articles (A) in a process room (21).

5. The method for shaping foodstuffs and the like as claimed in claim 4, further characterized in that:
said rotative drum (14) rotates substantially in the perpendicular direction, having said cutter blades (15) on its outer periphery, and the outer periphery of said rotative drum (14) is covered by a feeding guide unit (12), in order to form the process room (21) having a passage space which allows passing of one said process subject article (A); and
said cutter blades (15) rotate in the direction opposite to the dropping direction of said process subject articles (A).

6. The method for shaping foodstuffs and the like as claimed in claim 1, further characterized in that:
a mechanism for discharging cut skins (a2) is provided near said cutter blades (15).

7. A device for shaping foodstuffs and the like, by applying cutter blades (15) to process subject articles (A) in order to shape a surface of each of said process subject articles (A), characterized in that:
said process subject articles (A) and said cutter blades (15) are relatively moved, and said process subject articles (A) can be held in a floating state when said cutter blades (15) are applied to said process subject articles (A).

8. The device for shaping foodstuffs and the like as claimed in claim 7, further characterized in that:
said cutter blades (15) have a rotative tracking.

9. The device for shaping foodstuffs and the like as claimed in claim 7, further characterized in that:
said cutter blades (15) have a combined effective blade shape of a letter U.

10. The device for shaping foodstuffs and the like as claimed in claim 7, further characterized in that:
said relative movement is done by rotating a rotative drum (14) provided with said cutter blades (15), and through natural drop of said process subject articles (A) in a process room (21).

11. The device for shaping foodstuffs and the like as claimed in claim 10, further characterized in that:
said rotative drum (14) rotates substantially in the perpendicular direction, having said cutter blades (15) on its outer periphery, and the outer periphery of said rotative drum (14) is covered by a feeding guide unit (12), in order to form the process room (21) having a passage space which allows passing of one said process subject article (A); and
said cutter blades (15) rotate in the direction opposite to the dropping direction of said process subject articles (A).

12. The device for shaping foodstuffs and the like as claimed in claim 7, further characterized in that:
a mechanism for discharging cut skins (a2) is provided near said cutter blades (15).

13. The device for shaping foodstuffs and the like as claimed in claim 7, further characterized in that:
the device for shaping foodstuffs and the like (1) further comprises:
a shaping device body (2), in which said process subject articles (A) and said cutter blades (15) are relatively moved, and said process subject articles (A) can be held in a floating state when said cutter blades (15) are applied to said process subject articles (A); and
a preparation device (3A), which cuts said process subject articles (A) in advance to be in a predetermined shape so that a shaping process by said shaping device body (2) can be done easily;
said preparation device (3A) comprising:
a receive cylinder (4), continuously connected to a feeding mouth (22) of said shaping device body (2), and supporting one process subject article (A) at a process start end;
a feeding cutter blade (50), capable of being inserted in said receive cylinder (4) and having substantially the same inner shape as that of said receive cylinder (4); and
a mounting device (6) which places said process subject articles (A) on said receive cylinder (4) at predetermined intervals.

14. The device for shaping foodstuffs and the like as claimed in claim 13, further characterized in that:
said feeding cutter blade (50) is provided, at the center thereof, with a pushing rod (51) movable in the forward and rearward directions toward said receive cylinder (4), and with a force applying member, which applies force to said pushing rod (51) toward the inside of said receive cylinder (4).

15. The device for shaping foodstuffs and the like as claimed in claim 13, further characterized in that:
said receive cylinder (4) is provided substantially in a vertical state, in which a V-shape groove (40a) is formed in the top of said process start end (40).

16. The device for shaping foodstuffs and the like as claimed in claim 13, further characterized in that:
said mounting device (6) is provided with support rods for supporting process subject articles (A) on a feeding surface of a slat conveyor; and
slits (41) are formed in the vertical direction in said receive cylinder (4) in order to avoid collision of said cylinder with said support rods (61).

17. A shaped product, of which a surface is shaped by applying cutter blades (15) to a process subject article (A), characterized in that:
said process subject article (A) and said cutter blades (15) are relatively moved, and said process subject article (A) can be held in a floating state when said cutter blades (15) are applied to said process subject article (A); and
a surface of said process subject article (A) is shaped by a method as claimed in claim 1.

18. The shaped product as claimed in claim 17, further characterized in that:
said process subject article (A) is aroid, and is shaped to be spherical.

19. A shaped product, of which a surface is shaped by applying cutter blades (15) to a process subject article (A), characterized in that:
said process subject article (A) and said cutter blades (15) are relatively moved, and said process subject article (A) can be held in a floating state when said cutter blades (15) are applied to said process subject article (A); and
a surface of said process subject article (A) is shaped by a device as claimed in claim 7.
